(19) United States
(12) Patent Application Publication
(10) Pub. No.: US 2009/0079701 A1
(43) Pub. Date: Mar. 26, 2009

(54) Device and Method for Displaying Data and Receiving User Input

(76) Inventor: George Grosskopf, JR., Coram, NY (US)

Correspondence Address: Fay Kaplun & Marcin, LLP/ Motorola, 150 Broadway Suite 702, New York, NY, 10038, US

(21) Appl. No.: 11/860,697

(22) Filed: Sep. 25, 2007

(51) Int. Cl. G06F 3/041

(52) U.S. Cl. 345/173

(57) ABSTRACT

Described are a device and a method for displaying data and receiving user input. The device includes a display arrangement displaying an image; a sensing arrangement generating orientation data corresponding to detected changes in an orientation of the device; and a control arrangement adjusting one of an orientation and a location of the image in response to the orientation data

### FIELD OF INVENTION

The present application generally relates to devices and methods for displaying data and receiving user input.

### BACKGROUND INFORMATION

Electronic devices often include input arrangements for receiving user input. One type of input arrangement is a touch-sensitive display (e.g., a touch-screen). A conventional touch-screen displays an interactive image such as an image of a button or an icon that a user can engage via touching. Generally, an orientation and location of the image is fixed and cannot be changed. Thus, the conventional touch-screen always displays the image in the same manner. When the conventional touch-screen is oriented in an intended manner, the image will appear in a proper orientation relative to the user. That is, the user will be able to view the image as it was intended to be viewed by a designer or manufacturer of the conventional touch-screen (e.g., right-side-up). However, if the conventional touch-screen is not oriented in the intended manner (e.g., upside-down), reading of the image may be rendered difficult or impossible. For example, the user may be required to tilt his head in order to view the image as intended. Orienting the conventional touch-screen in an unintended manner may also shift the location of the image relative to the user. Because the location is fixed, re-orienting the conventional touch-screen will correspondingly move the image. This may be disruptive to the user, who may be accustomed to viewing the image at a specific location (e.g., at a bottom portion of the display). Thus, the user may be required to search for the image.

In addition, some devices allow the user to input a signature by directly signing on an input area of the display. The input area to obtain the signature is always allocated to one portion of the display, which causes excessive wear on that portion while remaining portions remain unaffected. Furthermore, when the display is re-oriented, the user may not be able to input his signature in a normal manner, since the input area is no longer oriented correctly.

### SUMMARY OF THE INVENTION

The present invention relates to a device and a method for displaying data and receiving user input. The device includes a display arrangement displaying an image; a sensing arrangement generating orientation data corresponding to detected changes in an orientation of the device; and a control arrangement adjusting one of an orientation and a location of the image in response to the orientation data. The method includes: generating orientation data corresponding to detected changes in an orientation of a device; determining the orientation of the device based on the orientation data; and displaying an image on a device display, the image corresponding to the determined orientation.

### BRIEF DESCRIPTION OF THE DRAWINGS

FIG. 1 shows a block diagram of a device according to an exemplary embodiment of the present invention.

FIG. 2 shows the device of FIG. 1 in a first orientation according to an exemplary embodiment of the present invention.

FIG. 3 shows the device of FIG. 1 in a second orientation according to an exemplary embodiment of the present invention.

FIG. 4 shows the device of FIG. 1 in a third orientation according to an exemplary embodiment of the present invention.

FIG. 5 shows a method according to an exemplary embodiment of the present invention.

### DETAILED DESCRIPTION

The present invention may be further understood with reference to the following description and the appended drawings, wherein like elements are provided with the same reference numerals. The exemplary embodiments of the present invention relate to devices and methods for displaying data and receiving user input. In particular, exemplary embodiments of the present invention will be described with reference to a device that includes a signature pad for receiving user input. However, those skilled in the art will understand that the present invention may also be implemented with any device that includes a display coupled to, or integral with, an input arrangement. Thus, other embodiments may include a non-interactive display in conjunction with a keypad, a touch screen coupled to a keyboard, a non-interactive display coupled to a touchpad, etc. The present invention may also be implemented with devices that include a display, but no input arrangement.

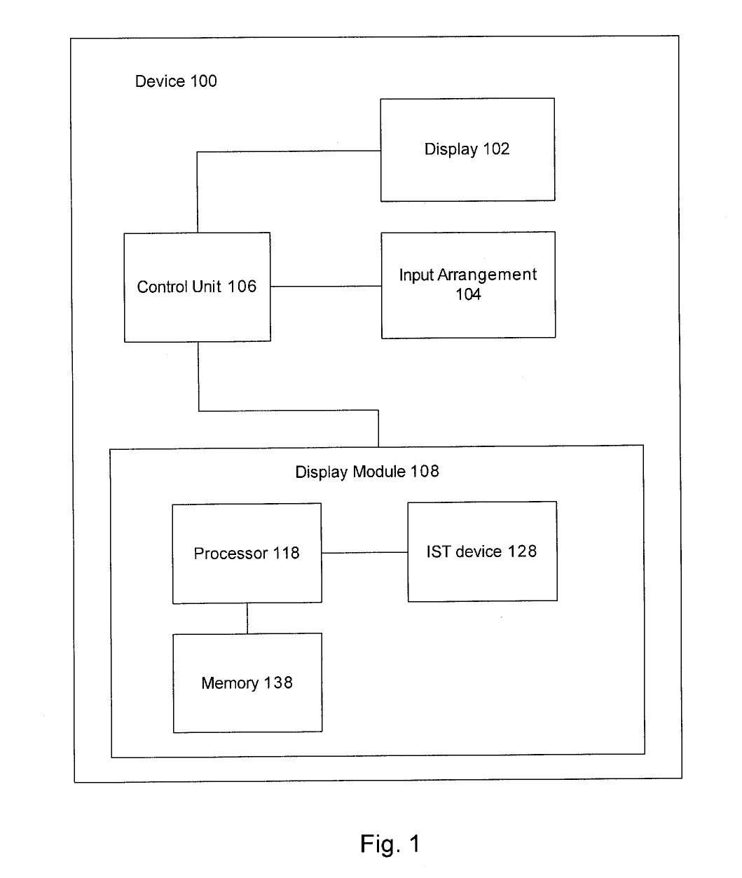

FIG. 1 shows a block diagram of an exemplary embodiment of a device 100 according to the present invention. The device 100 may be any electronic device that includes a display, such as a mobile computer, a cell phone, a laptop, a computer monitor, a personal digital assistant (“PDA”), a multimedia player, etc. The device 100 may include a display 102, an input arrangement 104, a control unit 106 and a display module 108. The display 102 may be any type of display such as a liquid crystal display, a plasma display, etc. In one embodiment, the display 102 may be touch-sensitive and function as an output component displaying text and/or graphics in addition to being an input component (e.g., a signature pad) receiving, for example, signature data from an instrument such as a pressure producing stylus or a pen. In some embodiments, the signature pad may utilize other types of data capturing technology such as, for example, capacitive touch, optical sensing or magnetic coupling technology.

The input arrangement 104 may comprise any number of conventional input arrangements such as a touch-sensitive display, a keypad, a keyboard, a pointing device, a mouse, etc. The input arrangement 104 may function as a sole input arrangement of the device 100 or, alternatively, may function in conjunction with the display 102 (e.g., the signature pad) to provide multiple input arrangements.

The control unit 106 may be a microprocessor, an embedded controller, an application-specific integrated circuit, or any other combination of hardware and/or software that controls the operation of one or more components of the device 100. The control unit 106 may, for example, control the displaying of images on the display 102. The control unit 106 may also receive input data from the display 102 and/or the input arrangement 104 and control operation of the device 100 based on user input.

The display module 108 may include a processor 118, an interactive sensing technology (“IST”) device 128 and a memory 138. The processor 118 may be communicatively coupled to the IST device 128 and the memory 138. As will be discussed in further detail below, the device 100 may control the display of images on the display 102 based on a physical orientation of the device 100. The IST device 128 may sense changes to the orientation of the device 100 and communicate this orientation data to the processor 118, which may then transmit the orientation data to the control unit 106 for controlling the operation of the display 102.

The IST device 128 may include a sensing arrangement for determining the orientation of the device 100. For example, the IST device 128 may be a micro-electromechanical system (“MEMS”) device containing a low-g accelerometer, which may be packaged as an integrated circuit. The IST device 128 may sense the device orientation by detecting motion and/or tilting of the device 100. For example, the IST device 128 may detect forces exerted upon the accelerometer in at least one direction (e.g., X, Y or Z directions). The orientation data may comprise a magnitude of the force exerted in the at least one direction, which may be generated by converting raw analog data from the accelerometer into digital data (e.g., by an analog-to-digital converter in the IST device 128). The orientation data may be obtained continuously in real time. Alternatively, in some embodiments the IST device 128 may sample the orientation data at predetermined intervals.

Those skilled in the art will understand that other types of sensing devices may also be utilized as an alternative to the IST device 128. For example, other embodiments may utilize any type of sensor that may be used to determine device orientation, such as optical sensors, motion sensors, etc.

The memory 138 may store one or more predetermined display configurations corresponding to the display of images on the display 102. For example, the memory 138 may include display configuration data that specifies an orientation of images that are displayed on the display 102. If the display 102 is the signature pad, the configuration data may also specify an orientation of input data (e.g., a signature) that is detected by the display 102. In this manner, the configuration data may control how the device 100 captures and/or recognizes signature data.

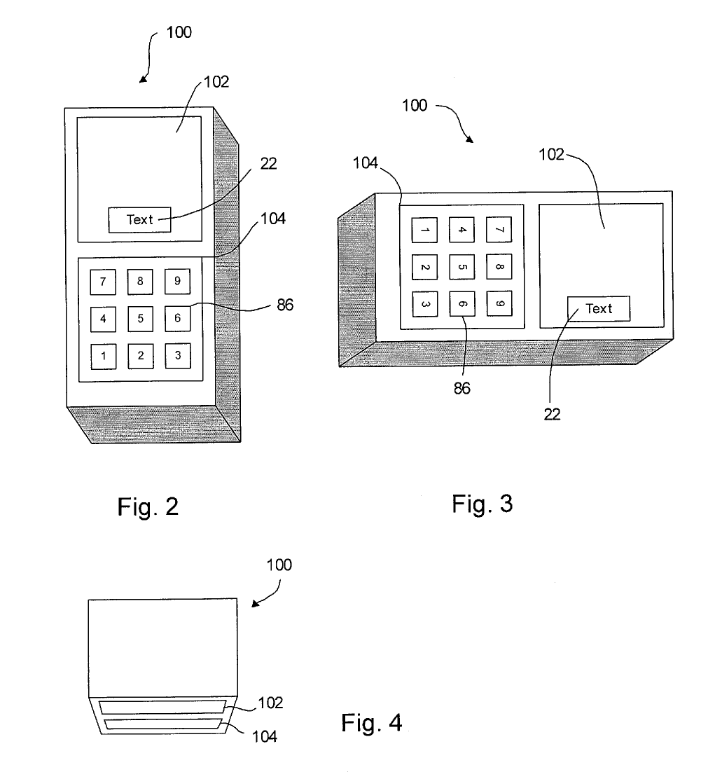

FIG. 2 shows an exemplary embodiment of the device 100 in a first orientation, which may be a default or normal orientation. As shown in FIG. 2, a longitudinal axis of the device 100 may be perpendicular to a horizontal plane. The display 102 may be operated to display any number or type of images, including graphics and text. The display 102 may show a text field 22, which is oriented in a direction corresponding to the first orientation. The text direction may vary according on a language in which the text is displayed. For example, if the text includes English words, the text orientation may be left-to-right and top-to-bottom. Other orientations (e.g., right-to-left) may correspond to other languages or alphabets.

If the display 102 is a signature pad, the text field 22 may comprise a blank input box in which the user may input his signature. An orientation of the input box 22 may also correspond to the first orientation. For example, if the input box 22 is a rectangle, the orientation may be such that a length of the rectangle is always displayed parallel to the horizontal plane.

In the first orientation the input box 22 may be oriented in the same manner as the input arrangement 104. For instance, the text field 22 may show text in the same direction as text shown on one or more keys 86 of the input arrangement 104. However, as will now be illustrated with reference to FIG. 3, the orientation of the text field 22 may differ from the orientation of the input arrangement 104 based on how the device 100 is oriented. More generally, the orientation of any image displayed on the display 102 may be a function of the orientation of the entire device 100 and, therefore, may not be in a static relationship with any portion (e.g., the input arrangement 104) of the device 100.

FIG. 3 shows an exemplary embodiment of the device 100 in a second orientation in which the device 100 has been rotated such that a longitudinal axis of the device 100 is substantially parallel to the horizontal plane. As shown in FIG. 3, the text field 22 has been shifted from its original position in FIG. 2 so as to appear parallel to the horizontal plane. In this particular orientation, the text field 22 is also perpendicular to text shown on the key 86. Thus, from the user's perspective, the text field 22 appears as would normally be expected.

FIG. 4 shows an exemplary embodiment of the device 100 in a third orientation in which the device 100 has been rotated about the horizontal axis so that a normally top surface of the device 100 now faces the user. The user may place the device 100 in the third orientation in an attempt to obscure the display 102 from viewing by other persons. For example, if the display 102 is currently displaying private information that the user does not wish to disclose, the user may rotate the device 100 into the third orientation, thereby orientating the display 102 away from a field-of-view of neighboring persons such as passersby and unexpected visitors.

As shown in FIG. 4, when in the third orientation, the display 102 may be configured to remove the entire text field 22. That is, the display 102 may be turned off or set to display a blank screen. The display 102 may also show a predetermined image that replaces the text field 22. In this manner, the device 100 may automatically hide the text field 22 when the third orientation is detected, thereby anticipating the user's desire to prevent others from viewing the display 102.

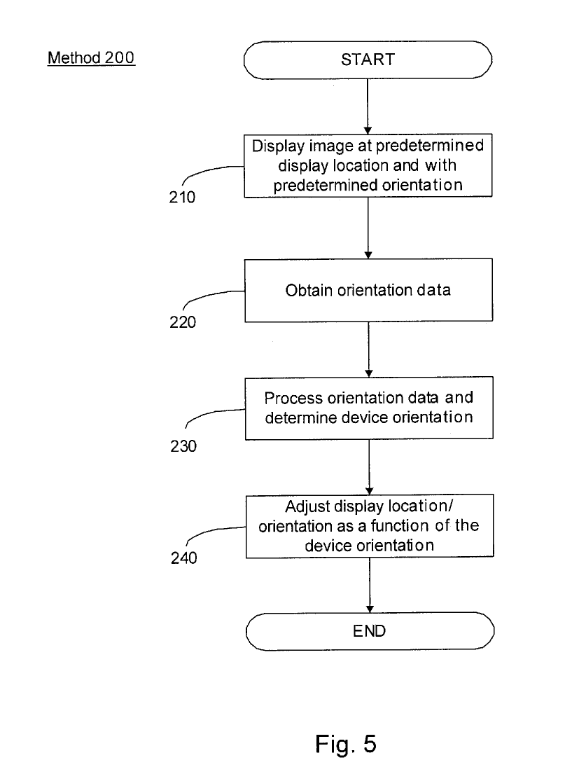

FIG. 5 shows an exemplary embodiment of a method 200 according to the present invention. The method 200 may be implemented on the device 100, but may also be implemented in any electronic device that includes a display and an ability to detect device orientation. In step 210, the device 100 displays an image at a predetermined display location and with a predetermined orientation. For example, the image may be the text field 22 and the predetermined display location may comprise a set of X and Y coordinates. Initially, the display location may be a location corresponding to the default location. As discussed above, the orientation of the image may depend on a language of text in the image. In general, the image orientation will correspond to a normal viewing orientation expected by the user.

In step 220, the device 100 obtains the orientation data, which is determined using the IST device 128. The processor 118 receives the orientation data and may calibrate the orientation data to compensate for changes in one or more orientation parameters. The orientation parameters may, for example, include an offset for a zero crossing of the one or more directions, a threshold value corresponding to a sensitivity of the device 100 to changes in gravity, and other parameters that may be adjusted to provide a more accurate determination of the actual orientation of the device 100. The processor 118 may perform further processing of the orientation data such as filtering out noise, encoding the orientation data, etc. The orientation data is then transmitted to the control unit 106.

In step 230, the device 100 further processes the orientation data and determines the orientation of the device 100. The control unit 106 may convert directional information (e.g., X, Y and Z axis data) included in the orientation data into angular measurements and determine how the device 100 is being held (e.g., tilted left, tilted right, upside down, etc.) based on the angular measurements.

In step 240, the device 100 adjusts the location and/or orientation of an image shown on the display 102. For example, in the normal orientation (e.g., the first orientation of FIG. 2), the display 102 may show a default screen. If the device 100 is tilted to the right (e.g., the second orientation of FIG. 3) the control unit 106 may instruct the display 102 to rotate all images to the right to match the orientation of the device 100. As discussed above, changing the device orientation may also trigger other display-related actions such as hiding an image temporarily until the device 100 is re-oriented. Changing the device orientation may also initiate specific programs such as a signature capture application that displays an input box for inputting the user's signature.

The exemplary embodiments of the present invention discussed above may enable user-friendly displaying of images. By reconfiguring the display 102 in response to situational awareness (e.g., knowledge regarding physical position and orientation), images may be displayed or hidden in a manner consistent with the user's expectations. Thus, if the device 100 is rotated, the user may continue to view an image in a normal manner without having to tilt his head. Sensitive information may also be protected by quickly tilting the device 100 in a predetermined direction.

The exemplary embodiments of the present invention may also enable ease of obtaining user input such as signature data. When the device 100 is rotated, an input box (e.g., the text field 22) may be corresponding rotated so as to appear in the normal manner. In addition, the device 100 will recognize that its orientation has changed and may adjust a reading of signature input to match the change in orientation. Thus, in the normal orientation, the device 100 may read signature data from left-to-right starting at a bottom portion of the display 102. If the device 100 is rotated to the right, the device 100 may read starting from a bottom-right corner to a top-right corner. However, from the user's perspective, the displaying and the reading of the input box remains substantially the same regardless of how the device 100 is rotated.

A further advantage of moving the input box may be reduced wear on the display 102. If the input box is always displayed in one location, repeated user input of signature data may cause premature wear of that location relative to other portions of the display 102. However, because the exemplary embodiments of the present invention may adjust the orientation and location of the input box in response to changes in the device orientation, other display locations are made available for receiving input and wear may be evenly distributed across multiple locations rather than confined to the one location. Thus, premature wear may be prevented.

The present invention has been described with reference to the above exemplary embodiments. One skilled in the art would understand that the present invention may also be successfully implemented if modified. For example, although the exemplary embodiments of the present invention have been described with reference to a plurality of processing arrangements (e.g., the control unit 106 and the processor 118), other embodiments may utilize a single processor that receives the orientation data and controls the display 102. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A device, comprising:
a display arrangement displaying an image;
a sensing arrangement generating orientation data corresponding to detected changes in an orientation of the device; and
a control arrangement adjusting one of an orientation and a location of the image in response to the orientation data.

2. The device of claim 1, wherein the display arrangement is a touch-sensitive display.

3. The device of claim 2, wherein the touch-sensitive display receives signature input at an input box of the image.

4. The device of claim 3, wherein when the image is adjusted, the device adjusts a reading of the input box to match the image adjustment.

5. The device of claim 1, wherein the adjusting comprises rotating the image.

6. The device of claim 5, wherein the rotation matches a change in the device orientation resulting from a rotation of the device.

7. The device of claim 1, wherein the adjusting comprises moving the image to maintain a position of the image relative to a viewer of the display arrangement.

8. The device of claim 1, wherein the adjusting comprises removing the image from display.

9. The device of claim 8, wherein the removing occurs in response to a moving of the display arrangement away from a field-of-view of a viewer.

10. The device of claim 8, wherein the image is replaced with a predetermined image.

11. The device of claim 1, wherein the sensing arrangement includes one of an accelerometer, an optical sensor and a motion sensor.

12. A method, comprising:
generating orientation data corresponding to detected changes in an orientation of a device;
determining the orientation of the device based on the orientation data; and
displaying an image on a device display, the image corresponding to the determined orientation.

13. The method of claim 12, further comprising:
generating further orientation data corresponding to further detected changes in the orientation of the device; and
adjusting one of an orientation and a location of the image in response to the further orientation data.

14. The method of claim 13, wherein the display is touch-sensitive.

15. The method of claim 14, wherein the display receives signature input at an input box of the image.

16. The method of claim 15, wherein when the image is adjusted, the device adjusts a reading of the input box to match the image adjustment.

17. The method of claim 13, wherein the adjusting comprises rotating the image to match a change in the device orientation resulting from a rotation of the device.

18. The method of claim 13, wherein the adjusting comprises moving the image to maintain a position of the image relative to a viewer of the display.

19. The method of claim 13, wherein the adjusting comprises removing the image from display.

20. The device of claim 19, wherein the removing occurs in response to a moving of the display away from a field-of-view of a viewer.

21. The device of claim 19, wherein the image is replaced with a predetermined image.

22. The device of claim 12, wherein the orientation data is generated by a sensing arrangement that includes one of an accelerometer, an optical sensor and a motion sensor.

23. A device, comprising:
a display means for displaying an image;
a sensing means for generating orientation data corresponding to detected changes in an orientation of the device; and
a control means for adjusting one of an orientation and a location of the image in response to the orientation data.
